(19) United States
(12) Patent Application Publication
(10) Pub. No.: US 2004/0123326 A1
(43) Pub. Date: Jun. 24, 2004

(54) Method and apparatus for allocating tuning devices to broadband head-end services

(75) Inventor: Douglas S. Makofka, Willow Grove, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: General Instrument Corporation

(21) Appl. No.: 10/322,399

(22) Filed: Dec. 18, 2002

(51) Int. Cl. H04N 7/173; H04N 7/16

(52) U.S. Cl. 725/100; 725/87; 725/91; 725/131; 725/133; 725/139; 725/151

(57) ABSTRACT

A method and apparatus for allocating a plurality of tuning devices to access services provided by a broadband network head-end. The tuning devices are controlled by a client device which schedules the tuning devices to access the services. The client device receives a plurality of requests for the services provided by the broadband network head-end. The number of requests exceeds the number of tuning devices. The client device automatically assigns each of the tuning devices to a specific one of the services.

### BACKGROUND OF THE INVENTION

1. Field of the Invention

The present invention generally relates to assigning cable television tuners to services in broadband networks.

2. Background Information

A new era in TV viewing experience has emerged in which multiple cable television services compete for tuner resources in a client device, such as a set-top box (STB) with dual tuners. In one situation, the client device may be in a stand-by mode where the display and input device(s) are inactive, blanked or turned off. When all tuners are in use, a scheduled event (e.g., a record) occurs. The client device must choose an action, such as ignoring the record event or re-assigning one of the tuners to the record event. In another situation, the client device acts as a “tuner farm” for other devices by providing a network access point. The other devices request services from the network access point. The client device needs to allocate tuners based on the services requested by the other devices. In yet another situation, there are background services set up in the network that run without user intervention that may need to be interrupted for user-specified service events.

Current dual-tuner devices have specific tuners assigned to specific activities and/or they do not support background operations without user interaction.

### SUMMARY OF THE INVENTION

The present invention is a method of allocating a plurality of tuning devices to access services provided by a broadband head-end. The tuning devices are controlled by a client device which schedules the tuning devices to access the services. The client device receives a plurality of requests for the services provided by the broadband head-end where the number of requests exceeds the number of tuning devices. The client device automatically assigns each of the tuning devices to a specific one of the services based on one of the class of the specific service, the persistence of the specific service, the priority of the specific service, the usage type of the specific service, and the access type of the specific service.

The client device may periodically reports tuning device scheduling decisions to the broadband head-end. Based on the reported scheduling decisions, the broadband head-end may adjust criteria used by the client device to make future tuning device allocation decisions.

The class of the specific service may be a broadcast television service, an impulse pay-per-view (IPPV) television service, a video-on-demand (VOD) service, an audio-only service, a data-only service, or a client-hosted service. At least one of the service requests may be discarded.

### BRIEF DESCRIPTION OF THE DRAWINGS

The following detailed description of preferred embodiments of the present invention would be better understood when read in conjunction with the appended drawings. For the purpose of illustrating the present invention, there are shown in the drawings embodiments which are presently preferred. However, the present invention is not limited to the precise arrangements and instrumentalities shown. In the drawings:

FIG. 1 shows a block diagram operating in accordance with the present invention;

FIG. 2 shows the functionality of a client device used to schedule tuning devices to access services provided by a broadband head-end in accordance with the present invention; and

FIG. 3 is a flow chart including method steps used to allocate a plurality of tuning devices to access services provided by a broadband head-end in accordance with the present invention.

### DETAILED DESCRIPTION OF THE INVENTION

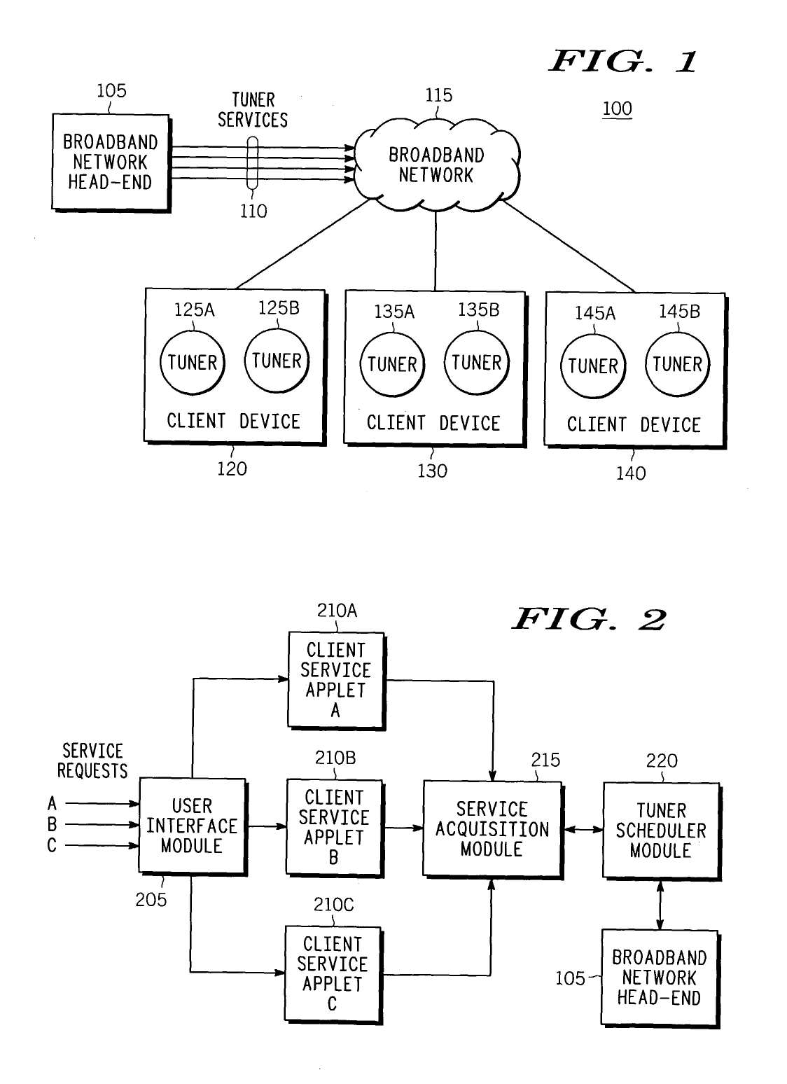

FIG. 1 shows a cable television system 100 including a broadband network head-end 105 which is used to host, store, and transmit and receive communication tuner services 110 via broadband network 115 to client devices 120, 130, 140 in accordance with the present invention. Each client device includes a plurality of tuners. As shown in FIG. 1, client device 120 includes tuning devices (i.e., tuners) 125A, 125B; client device 130 includes tuning devices 135A, 135B; and client device 140 includes tuning devices 145A, 145B. One-way and/or two-way communications may be used to aid in assigning and scheduling the tuning devices 125A, 125B, 135A, 135B, 145A, 145B with corresponding tuner services.

The present invention defines classes of services. These service classifications are carried in the network. Each class type is given a priority relative to other service class types. Tuner conflicts are resolved between class types on a priority basis. Services are assigned a presentation priority based on how and when they are presented to the user. Services that are presented immediately are prioritized above services that are cached for future presentation. Services are assigned a persistence priority. Priority is given to services based on how long their content exists in the broadband network. Services with long persistence can be delayed, while services with (relatively) shorter persistence can be assigned a tuner (for example).

There are scheduling policies assigned to clients in the network. These policies, which may change over time, describe how a client device should acquire services in the face of tuner or other resource conflicts. These policies are made up of priority information as described above, plus classical scheduling algorithms, such as used in traffic, CPU, bandwidth, and other disciplines.

Network-sided scheduling commands allow the clients to accept specific scheduling commands from the network. These commands can be based on general information that exists about the services that are being offered or specific information about the set of services that a specific client device needs to access. These commands can be used in conjunction with the scheduling policies described above, as exceptions to scheduling policies, or in place of them. These commands may assign specific sequences of service, acquisitions to specific tuners, or supply higher-level tuner acquisition commands (e.g., “use tuner 2 for trickle only”).

The tuner services may include data, audio, video, web pages, telephone calls, or the like. The tuner services may be presented to the client devices 120, 130, 140 as part of (or the whole of) information that is to be displayed, stored, or forwarded by the client devices 120, 130, 140. The tuner services may be broadcast, multicast, or narrowcast (unicast).

The client devices 120, 130, 140 may be any device that contains more than one tuner that can be used simultaneously with the other tuners in the device to access tuner services. The client devices 120, 130, 140 may access these tuner services for internal use, or on behalf of others of the client devices. Each of the client devices 120, 130, 140 may present these services to the user, store them for future access by itself of another client device, or forward them directly to another client device.

FIG. 2 shows the functionality of a client device in accordance with the present invention. A user interface module 205 residing in the client device receives service requests A, B, C (i.e., commands) from a user and forwards them to the appropriate client service applets 210A, 210B, 210C for processing. The user interface module 205 may be a web browser or other graphical user interface (GUI). The user has access to results obtained in response to the service requests. The results may be displayed on a screen device. Each of service applets 210A, 210B, 210C use generic description information to find and tune services provided by broadband network head-end 105. In response to receiving service requests A, B and C, the client service applets requests service acquisition from service acquisition module 215, which in turn requests a tuner from tuner scheduler module 220. The tuner scheduler module 220 communicates with broadband network head-end 105 to assign tuners in response to the service acquisition requests, and resolves inter-request conflicts as is necessary.

Service scheduling is based on several service attributes including service class, service persistence, service priority, service usage type, service access type, and service class. The broadband network 115 contains a number of well-known service classes including broadcast television (TV) service, impulse pay-per-view (IPPV) TV service, video-on-demand (VOD) service, audio-only service, data-only service, and client-hosted service.

Service classes specify default values for many parameters that are needed to access the service, some of which may be overridden by the other attributes used in service scheduling on a service-by-service basis.

Service persistence is a service that may persist for just a single “viewing” as is the case with a normal broadcast service, or it may persist for a period of time, as is the case with a VOD service. Sometimes, the normal persistence of a service may be modified. An example of this is when services are cached in the network for an on-demand presentation. In this case, a broadcast service may persist in the network for some period of time and thus the service persistence attribute overrides the persistence associated with the broadcast service class.

With periodic connectivity, the client can communicate with the broadband network head-end based on a poll, or some other event. However, it is not assumed that the client device can communicate on-demand to the head-end. In this situation, the client can periodically tell the head-end what decisions it has made, and the broadband network head-end can adjust the client's scheduling method based on this report.

Service priority provides a mechanism for an arbitrary relative ranking of services. All other things being equal, a higher ranking service overrides a lower ranking service. There are many options for how to apply priority against other scheduling attributes. In fact, scheduling attributes could be easily applied differently for different priority levels.

Service usage type denotes how a service to be used can affect the relative importance of its acquisition. A service that is cached for future use may not need to be accessed immediately, unlike a service that is going to be viewed right now. This parameter is usually client supplied, whereby it is provided by the client device based on what the service is used for.

The service access type describes how a particular service is to be access controlled. This is important to know when determining if a currently tuned service can be aborted. For example, it may be better to abort a basic subscription service than an IPPV service.

The tuner scheduler module 220 uses one or more algorithms to determine what tuner to allocate to a service request, or if a currently-tuned service should be aborted to support a new service tuner request. A configurable scheduler algorithm may be used to process commands and/or data from software running on the client device or from another source. The commands and/or data may include instructions on how to process service tuner requests based on predetermined scheduling information received via an out-of-band (OOB) channel, a Data Over Cable Systems Interface Specification (DOCSIS) channel, or an in-band channel. A configurable schedule may have a default behavior that is then adjusted or re-programmed by the configuration data. Configuration information for scheduling tuners may indicate when to choose to abort one type of service to handle a tuner request for another type of service, how to handle conflicts between services when there are multiple conflicting parameters (e.g., service A is of higher priority than service B, but service B is to be presented, and service A is to be cached), etc. New service types and rules for handling the new type may be added and/or removed as desired by the programmer of the scheduling algorithm.

A one-way configurable tuner scheduler takes command/data information from the system and uses it to configure its behavior. A periodic two-way configurable tuner scheduler keeps track of scheduling decisions it has made, and periodically reports them to the broadband network head-end 105 which then uses this information to adjust the client's scheduling behavior. The two-way configurable tuner scheduler communicates with the broadband network head-end 105 to resolve scheduling conflicts, such as by hosting negotiations between the client device and another device in the network. The response of the broadband network head-end 105 is then used to update the scheduler's future behavior. Another variation is the scheduler is distributed between the client device 120, 130, 140 and the broadband network head-end 105, with every scheduling decision made based on a transaction between the client devices 120, 130, 140 and the broadband network head-end 105.

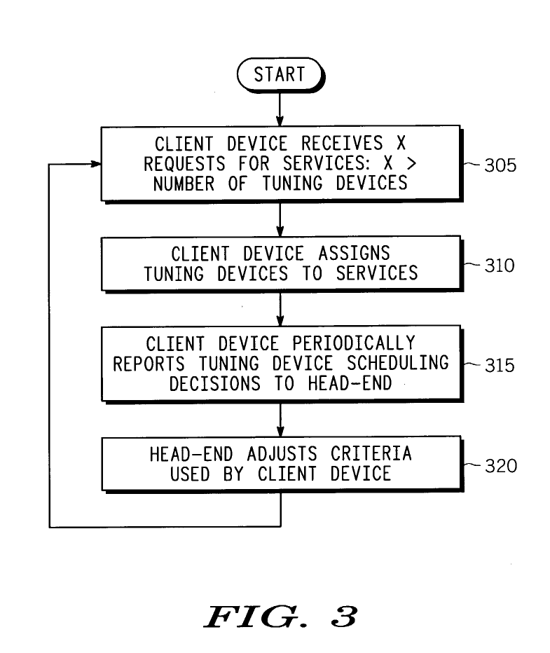

FIG. 3 is a flow chart including the method steps of allocating a plurality of tuning devices to access services provided by a broadband head-end in accordance with the present invention. The tuning devices are controlled by a client device which schedules the tuning devices to access the services. In step 305, the client device receives a plurality of requests (“X”) for the services provided by the broadband network head-end. The number of requests exceed the number of tuning devices. In step 310, the client device automatically assigns each of the tuning devices to a specific one of the services. The assignment may be based on the class of the specific service, the persistence of the specific service, the priority of the specific service, the usage type of the specific service, or the access type of the specific service. In step 315, the client device periodically reports tuning device scheduling decisions to the broadband network head-end. In step 320, based on the reported scheduling decisions, the broadband network head-end adjusts criteria used by the client device to make future tuning device allocation decisions.

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A method of allocating a plurality of tuning devices to access services provided by a broadband head-end, the tuning devices being controlled by a client device which schedules the tuning devices to access the services, the method comprising:
(a) the client device receiving a plurality of requests for the services provided by the broadband head-end, the number of requests exceeding the number of tuning devices; and
(b) the client device automatically assigning each of the tuning devices to a specific one of the services based on the class of the specific service.

2. The method of claim 1 further comprising:
(c) the client device periodically reporting tuning device scheduling decisions to the broadband head-end; and
(d) based on the reported scheduling decisions, the broadband head-end adjusting criteria used by the client device to make future tuning device allocation decisions.

3. The method of claim 1 wherein the class of the specific service is a broadcast television service.

4. The method of claim 1 wherein the class of the specific service is an impulse pay-per-view (IPPV) television service.

5. The method of claim 1 wherein the class of the specific service is a video-on-demand (VOD) service.

6. The method of claim 1 wherein the class of the specific service is an audio-only service.

7. The method of claim 1 wherein the class of the specific service is a data-only service.

8. The method of claim 1 wherein the class of the specific service is a client-hosted service.

9. The method of claim 1 wherein at least one of the service requests is discarded.

10. A method of allocating a plurality of tuning devices to access services provided by a broadband head-end, the tuning devices being controlled by a client device which schedules the tuning devices to access the services, the method comprising:
(a) the client device receiving a plurality of requests for the services provided by the broadband head-end, the number of requests exceeding the number of tuning devices; and
(b) the client device automatically assigning each of the tuning devices to a specific one of the services based on the persistence of the specific service.

11. The method of claim 10 further comprising:
(c) the client device periodically reporting tuning device scheduling decisions to the broadband head-end; and
(d) based on the reported scheduling decisions, the broadband head-end adjusting criteria used by the client device to make future tuning device allocation decisions.

12. A method of allocating a plurality of tuning devices to access services provided by a broadband head-end, the tuning devices being controlled by a client device which schedules the tuning devices to access the services, the method comprising:
(a) the client device receiving a plurality of requests for the services provided by the broadband head-end, the number of requests exceeding the number of tuning devices; and
(b) the client device automatically assigning each of the tuning devices to a specific one of the services based on the priority of the specific service.

13. The method of claim 12 further comprising:
(c) the client device periodically reporting tuning device scheduling decisions to the broadband head-end; and
(d) based on the reported scheduling decisions, the broadband head-end adjusting criteria used by the client device to make future tuning device allocation decisions.

14. A method of allocating a plurality of tuning devices to access services provided by a broadband head-end, the tuning devices being controlled by a client device which schedules the tuning devices to access the services, the method comprising:
(a) the client device receiving a plurality of requests for the services provided by the broadband head-end, the number of requests exceeding the number of tuning devices; and
(b) the client device automatically assigning each of the tuning devices to a specific one of the services based on the usage type of the specific service.

15. The method of claim 14 further comprising:
(c) the client device periodically reporting tuning device scheduling decisions to the broadband head-end; and
(d) based on the reported scheduling decisions, the broadband head-end adjusting criteria used by the client device to make future tuning device allocation.

16. A method of allocating a plurality of tuning devices to access services provided by a broadband head-end, the tuning devices being controlled by a client device which schedules the tuning devices to access the services, the method comprising:
(a) the client device receiving a plurality of requests for the services provided by the broadband head-end, the number of requests exceeding the number of tuning devices; and
(b) the client device automatically assigning each of the tuning devices to a specific one of the services based on the access type of the specific service.

17. The method of claim 16 further comprising:
(c) the client device periodically reporting tuning device scheduling decisions to the broadband head-end; and
(d) based on the reported scheduling decisions, the broadband head-end adjusting criteria used by the client device to make future tuning device allocation decisions.
